(19) United States
(12) Patent Application Publication
(10) Pub. No.: US 2026/0122342 A1
(43) Pub. Date: Apr. 30, 2026

(54) IMAGE CAPTURING APPARATUS, CONTROL METHOD THEREFOR, AND MEDIUM

(71) Applicant: CANON KABUSHIKI KAISHA, Tokyo (JP)

(72) Inventor: Saki CHIBA, Kanagawa (JP)

(21) Appl. No.: 19/359,861

(22) Filed: Oct. 16, 2025

(30) Foreign Application Priority Data
Oct. 28, 2024 (JP) 2024-189196

(51) Int. Cl. H04N 23/60; H04N 23/62

(52) U.S. Cl. CPC H04N 23/64; H04N 23/62

(57) ABSTRACT

An image capturing apparatus executes first processing with respect to target image data in response to the operation in the first step on the first operation member, and executes second processing with respect to the target image data in response to the operation in the second step on the first operation member. The first processing is processing for performing one of rating setting and protection setting with respect to the target image data, and the second processing is processing for performing another one of the rating setting and the protection setting.

### BACKGROUND

### Field of the Technology

A technique according to the present disclosure relates to an image capturing apparatus that includes an operation member having a two-step depression structure, a control method therefor, and a medium.

### DESCRIPTION OF THE RELATED ART

Conventionally, an image capturing apparatus has functions of providing a rating and protection to a captured image. The functions of providing these include a function call-up by way of selection of items from a MENU screen, and a function call-up by way of depression of independent operation buttons on an image capturing apparatus to which the rating function and the protection function have been assigned, respectively.

However, according to the aforementioned functions, in a case where both of the rating and protection functions are to be applied to one captured image, it is necessary to perform an operation of calling up one function after performing an operation of calling up another function; consequently, the operations can be cumbersome, and a call-up of one of the functions can be forgotten. Especially, when an image is not provided with protection as a result of forgetting to call up the protection function, there is a possibility that the image be erased by mistake.

As a measure against this, a method has been proposed that provides a plurality of switches, selects one of groups of function combinations using one switch, and actuates each of the functions corresponding to the combinations using the remaining switches (Japanese Patent Laid-Open No. 10-97821). Furthermore, a method has been proposed that, when a certain function and another function are desired to be actuated, calls up the functions to be actuated separately using one button (Japanese Patent Laid-Open No. 2001-346080).

However, according to the conventional technique disclosed in Japanese Patent Laid-Open No. 10-97821, the plurality of switches are provided separately, and it is thus necessary to ensure a large space therefor.

Furthermore, according to the conventional technique disclosed in Japanese Patent Laid-Open No. 2001-346080, in order to reduce the operational steps in switching between image capturing modes for the purpose of saving a still image during recording of moving images, moving images are recorded by half-pressing an operation member for image-capturing (a release button), whereas a still image is saved by fully pressing the operation member.

However, there are case where the release button is desired to be used exclusively for a release function for capturing a still image.

### SUMMARY

The present disclosure provides an image capturing apparatus capable of proving a rating and protection to an image with use of an operation member which is different from a release button and which can be depressed in two steps.

According to an aspect of the present disclosure, provided is an image capturing apparatus, comprising: a first operation member that has a structure for operations in respective steps that include a first step and a second step; at least one memory storing instructions; and at least one processor that is in communication with the at least one memory and that, when executing the instructions, cooperates with the at least one memory to execute processing, the processing including executing first processing with respect to target image data in response to the operation in the first step on the first operation member, and executing second processing with respect to the target image data in response to the operation in the second step on the first operation member, wherein the first processing is processing for performing one of rating setting and protection setting with respect to the target image data, and the second processing is processing for performing another one of the rating setting and the protection setting.

According to the aforementioned configuration, a plurality of functions related to predetermined processing can be used separately with use of one operation member on which a plurality of depression operations can be performed, and the operational steps can be reduced.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a configuration of an image capturing apparatus as a first embodiment.

FIG. 2A is an external view of the image capturing apparatus as the first embodiment.

FIG. 2B is an external view of the image capturing apparatus as the first embodiment.

FIG. 3 is a flowchart for a case where a first step and a second step of an operation member have been set for a rating and protection, respectively.

FIG. 4A is a flowchart of processing for changing a rating level that has already been provided.

FIG. 4B is a flowchart of processing for changing a rating level using another member.

FIG. 5A is a flowchart of processing for causing a user to select cancellation of protection.

FIG. 5B is a flowchart of processing for causing a user to select cancellation of protection.

FIG. 5C is a flowchart of processing for causing a user to select cancellation of protection.

FIG. 6A is a flowchart of processing for causing the user to select cancellation of protection in accordance with a period for which the operation member has been depressed to the second step.

FIG. 6B is a flowchart of processing for causing the user to select cancellation of protection in accordance with a period for which the operation member has been depressed to the second step.

FIG. 6C is a flowchart of processing for causing the user to select cancellation of protection in accordance with a period for which the operation member has been depressed to the second step.

FIG. 7 is a flowchart for a case where the first step and the second step of the operation member have been set for protection and a rating, respectively.

FIG. 8A is a flowchart of processing for changing a rating level.

FIG. 8B is a flowchart of processing for changing a rating level.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Block Diagram of Digital Camera

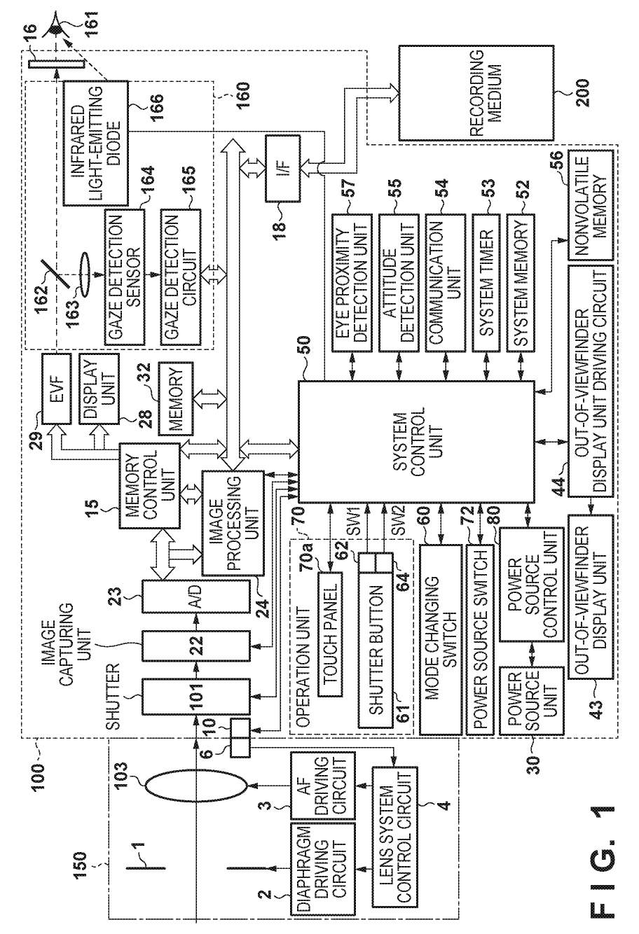

FIG. 1 is a block diagram showing an exemplary configuration of a digital camera 100, which is an image capturing apparatus as an embodiment. In FIG. 1, a lens unit 150 is a lens unit equipped with interchangeable image capturing lenses. A lens 103 is normally composed of a plurality of lenses; here, however, only one lens is illustrated thereas for simplicity. A communication terminal 6 is a communication terminal that is intended for the lens unit 150 to communicate with the digital camera 100. The lens unit 150 communicates with a system control unit 50 via this communication terminal 6 and a communication terminal 10 of the digital camera 100, and controls a diaphragm 1 via a diaphragm driving circuit 2 with use of a lens system control circuit 4 thereinside. Thereafter, focus is achieved by displacing the lens 103 via an AF driving circuit 3.

A shutter 101 is a focal-plane shutter capable of freely controlling an exposure time period of an image capturing unit 22 under control of the system control unit 50.

The image capturing unit 22 is an image sensor composed of, for example, a CCD or CMOS element that converts an optical image into electrical signals. An A/D converter 23 is used to convert analog signals output from the image capturing unit 22 into digital signals.

An image processing unit 24 executes predetermined pixel interpolation, resize processing like reduction, and color conversion processing with respect to data from the A/D converter 23, or data from a later-described memory control unit 15. Also, the image processing unit 24 executes predetermined computation processing using captured image data. The system control unit 50 performs exposure control and range-finding control based on the computation result obtained by the image processing unit 24. As a result, autofocus (AF) processing, automatic exposure (AE) processing, preliminary flash emission (EF) processing, and subject detection processing of the through-the-lens (TTL) method are executed. The image processing unit 24 further executes predetermined computation processing using captured image data, and executes auto white balance (AWB) processing of the TTL method based on the obtained computation result.

A memory control unit 15 controls data transmission/reception among the A/D converter 23, the image processing unit 24, and a memory 32. Output data from the A/D converter 23 is written directly into the memory 32 via the image processing unit 24 and the memory control unit 15, or via the memory control unit 15. The memory 32 stores image data that has been obtained by the image capturing unit 22 and converted into digital data by the A/D converter 23, and image data to be displayed on a display unit 28 and an EVF 29. The memory 32 has a storage capacity sufficient to store a predetermined number of still images, and moving images and audio of a predetermined time period.

Furthermore, the memory 32 also functions as a memory for image display (a video memory). Image data for display that has been written into the memory 32 is displayed by the display unit 28 and the EVF 29 via the memory control unit 15. The display unit 28 and the EVF 29 performs display on a display device, such as an LCD and an organic EL, in accordance with signals from the memory control unit 15. Pieces of data that have undergone A/D conversion in the A/D converter 23 and have been accumulated in the memory 32 are sequentially transferred to and displayed on the display unit 28 or the EVF 29; as a result, live-view display (LV display) can be performed. Hereinafter, images that are displayed in a live-view form will be referred to as live-view images (LV images).

An infrared light-emitting diode 166 is a light-emitting element for detecting a gaze position of a user on a viewfinder screen, and irradiates an eyeball (eye) 161 of the user that has come into proximity to an eye proximity unit 16 with infrared light. The infrared light emitted by the infrared light-emitting diode 166 is reflected by the eyeball (eye) 161, and the reflected infrared light reaches a dichroic mirror 162. The dichroic mirror 162 reflects only the infrared light, and allows visible light to be transmitted therethrough. The reflected infrared light whose optical path has been changed forms an image on an image capturing plane of a gaze detection sensor 164 via an image forming lens 163. The image forming lens 163 is an optical member composing a gaze detection optical system. The gaze detection sensor 164 is composed of an image capturing device, such as a CCD image sensor.

The gaze detection sensor 164 photoelectrically converts the reflected infrared light incident thereon into electrical signals, and outputs the electrical signals to a gaze detection circuit 165. The gaze detection circuit 165 includes at least one processor, detects the gaze position of the user from an image or a motion of the eyeball (eye) 161 of the user based on output signals from the gaze detection sensor 164, and outputs detected information to the system control unit 50. In this way, the dichroic mirror 162, the image forming lens 163, the gaze detection sensor 164, the infrared light-emitting diode 166, and the gaze detection circuit 165 compose a gaze detection block 160.

The technique according to the present disclosure detects gaze using the gaze detection block 160 based on a method called a corneal reflex method. The corneal reflex method is a method in which the direction and position of gaze are detected from the positional relationship between reflected light, which is the infrared light that has been emitted by the infrared light-emitting diode 166 and reflected especially by a cornea of the eyeball (eye) 161, and a pupil of the eyeball (eye) 161. Other than this, there are also a variety of methods for detecting the direction and position of gaze, such as a method called a sclera reflection method, which makes use of the difference in light reflectance between the pupil and the white of the eye. Note that methods of gaze detection means other than the above-described methods may be used, as long as they are methods capable of detecting the direction and position of gaze.

An out-of-viewfinder liquid crystal display unit 43 displays a variety of setting values of the camera, including the shutter speed and the diaphragm, via an out-of-viewfinder display unit driving circuit 44.

A nonvolatile memory 56 is an electrically erasable and recordable memory; for example, a Flash-ROM or the like is used thereas. Constants for the operations of the system control unit 50, a program, and the like are stored in the nonvolatile memory 56. The program mentioned here denotes a computer program for executing various types of flowcharts that will be described later in the present embodiments.

The system control unit 50 is a control unit composed of at least one processor (or CPU) or circuit, and controls the entirety of the digital camera 100. Each process of the present embodiments, which will be described later, is realized by executing the aforementioned program recorded in the nonvolatile memory 56. For example, a RAM is used as a system memory 52, and constants and variables for the operations of the system control unit 50, the program that has been read out from the nonvolatile memory 56, and the like are deployed to the system memory 52. Furthermore, the system control unit 50 also performs display control by controlling the memory 32, the display unit 28, and the like.

A system timer 53 is a time measurement unit that measures time periods used in various types of control, and the time of a built-in clock.

A mode changing switch 60, a first shutter switch 62, a second shutter switch 64, and an operation unit 70 are operation means for inputting various types of operational instructions to the system control unit 50. The mode changing switch 60 changes an operation mode of the system control unit 50 to one of a still image capturing mode, a moving image capturing mode, and so forth. Modes included in the still image capturing mode are an auto capturing mode, an auto scene distinction mode, a manual mode, a diaphragm priority mode (Av mode), a shutter speed priority mode (Tv mode), and a program AE mode (P mode). They also include various types of scene modes in which image capturing settings vary for each scene to be captured, a custom mode, and so forth. The mode changing switch 60 enables the user to change directly to one of these modes. Alternatively, after switching to a screen of a list of image capturing modes with use of the mode changing switch 60, one of the plurality of modes that have been displayed may be selected, and another operation member may be used to switch thereto. Similarly, the moving image capturing mode may also include a plurality of modes.

The first shutter switch 62 is turned ON and generates a first shutter switch signal SW1 halfway through an operation performed on a shutter button 61 provided in the digital camera 100, that is to say, when the shutter button 61 is half-pressed (an image capturing preparation instruction). The first shutter switch signal SW1 causes image capturing preparation operations, such as autofocus (AF) processing, automatic exposure (AE) processing, auto white balance (AWB) processing, and preliminary flash emission (EF) processing, to be started.

The second shutter switch 64 is turned ON and generates a second shutter switch signal SW2 upon completion of the operation performed on the shutter button 61, that is to say, when the shutter button 61 is fully pressed (an image capturing instruction). Based on the second shutter switch signal SW2, the system control unit 50 starts a sequence of operations of image capturing processing, from readout of signals from the image capturing unit 22 to writing of a captured image as an image file into a recording medium 200.

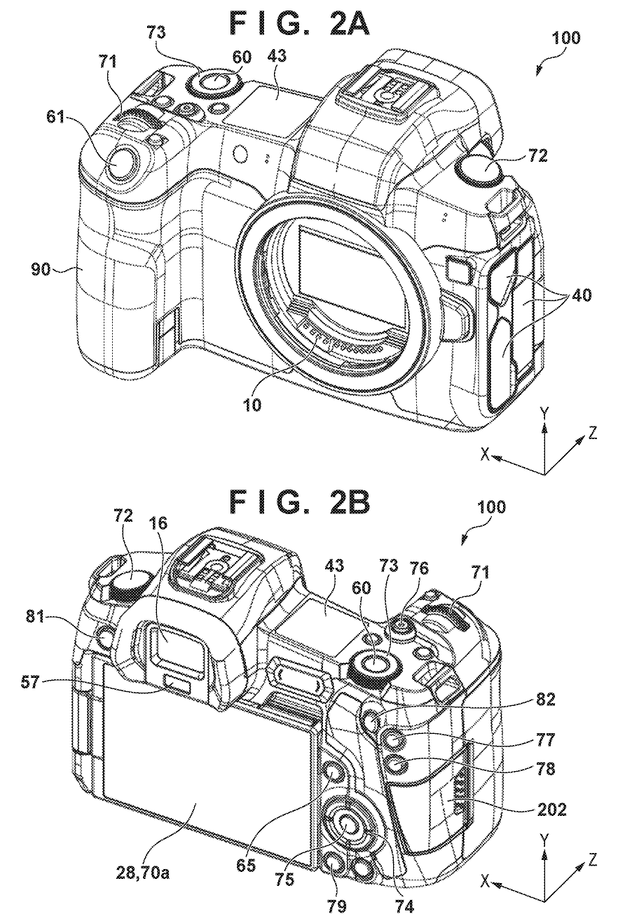

The operation unit 70 represents various types of operation members that act as an input unit that accepts an operation from the user. The operation unit 70 includes at least the following operation units. These operation units are the shutter button 61, a multi-controller 65, a touch panel 70a, a main electronic dial 71, a power source switch 72, a sub electronic dial 73, a direction key 74, and a SET button 75. Furthermore, these operation units are a moving image button 76, an AE lock button 77, a magnification button 78, a reproduction button 79, a menu button 81, and an AF start button 82. Note that the buttons, switches, and keys that have been listed above are not shown in FIG. 1, but are shown in later-described FIG. 2A and FIG. 2B, except for the shutter button 61, the touch panel 70a, and the power source switch 72.

A power source control unit 80 is composed of a battery detection circuit, a DC-DC converter, a switch circuit that changes a block to which current is supplied, and the like, and detects whether a battery is loaded, a battery type, and a remaining battery level. Also, the power source control unit 80 controls the DC-DC converter based on the results of the foregoing detection and an instruction from the system control unit 50, and supplies a necessary voltage for a necessary time period to each unit, including the recording medium 200. A power source unit 30 is composed of, for example, a primary battery like an alkaline battery or a lithium battery, a secondary battery like a NiCd battery, a NiMH battery, or a Li battery, or an AC adapter.

A recording medium I/F 18 is an interface with the recording medium 200, which is a memory card, a hard disk, and the like. The recording medium 200 is a recording medium, such as a memory card, for recording captured images, and is composed of a semiconductor memory, a magnetic disk, and the like.

A communication unit 54 establishes connection wirelessly or via a wired cable, and transmits/receives video signals and audio signals. The communication unit 54 is also connectable to a wireless local area network (LAN) and the Internet. Furthermore, the communication unit 54 can communicate with an external device also via Bluetooth® and Bluetooth Low Energy. The communication unit 54 can transmit images captured by the image capturing unit 22 (including live-view images) and images recorded in the recording medium 200, and can also receive images and other various types of information from an external device.

An attitude detection unit 55 detects an attitude of the digital camera 100 relative to the gravity direction. Based on the attitude detected by the attitude detection unit 55, it is possible to distinguish whether an image captured by the image capturing unit 22 is an image that was captured while the digital camera 100 was held in a landscape orientation or an image that was captured while the digital camera 100 was held in a portrait orientation. The system control unit 50 can add direction information corresponding to the attitude detected by the attitude detection unit 55 to an image file of an image captured by the image capturing unit 22, and can rotate an image and record the rotated image. For example, an acceleration sensor or a gyro sensor can be used as the attitude detection unit 55. A motion of the digital camera 100 (e.g., whether the digital camera 100 is panned, tilted, lifted, or stationary) can also be detected using the acceleration sensor or the gyro sensor acting as the attitude detection unit 55.

An eye proximity detection unit 57 is an eye proximity detection sensor that detects the approach (eye proximity) and separation (eye separation) of the eye (object) 161 to and from the eye proximity unit 16 of the viewfinder (approach detection). The system control unit 50 switches between display (a displaying state) and non-display (a non-displaying state) of the display unit 28 and the EVF 29 in accordance with the state detected by the eye proximity detection unit 57. More specifically, in a case where at least the digital camera 100 is in a capturing standby state and the setting of switching of a display destination of live-view images captured by the image capturing unit 22 is the automatic switching setting, the display unit 28 is set as the display destination and its display is turned ON, and the EVF 29 displays nothing, while the eye is not in proximity. Also, while the eye is in proximity, the EVF 29 is set as the display destination and its display is turned ON, and the display unit 28 displays nothing. For example, an infrared proximity sensor can be used as the eye proximity detection unit 57, which can detect the approach of some sort of object to the eye proximity unit 16 of the viewfinder in which the EVF 29 is built. In a case where an object has approached, infrared light projected from a light projection unit (not shown) of the eye proximity detection unit 57 is reflected and received by a light receiving unit (not shown) of the infrared proximity sensor. It is also possible to distinguish at what distance the approaching object is situated from the eye proximity unit 16 (an eye proximity distance) based on the amount of the received infrared light. In this way, the eye proximity detection unit 57 performs eye proximity detection for detecting a distance at which the object is approaching the eye proximity unit 16. Note, it is assumed in the present embodiments that the light projection unit and the light receiving unit of the eye proximity detection unit 57 are devices different from the above-described infrared light-emitting diode 166 and gaze detection sensor 164. However, the infrared light-emitting diode 166 may also function as the light projection unit of the eye proximity detection unit 57. Also, the gaze detection sensor 164 may also function as the light receiving unit. It is assumed that eye proximity is detected in a case where an approaching object at a predetermined distance or less from the eye proximity unit 16 has been detected in a non-eye proximity state (non-approaching state). It is assumed that eye separation is detected in a case where an object whose approach was detected has moved away by a predetermined distance or more in an eye proximity state (approaching state). For example, hysteresis may be present so that a threshold for detecting eye proximity differs from a threshold for detecting eye separation. Furthermore, it is assumed that a detection of eye proximity is followed by the eye proximity state, until eye separation is detected. It is assumed that a detection of eye separation is followed by the non-eye proximity state, until eye proximity is detected. Note that the infrared proximity sensor is an example, and another sensor may be adopted as the eye proximity detection unit 57 as long as it can detect the approach of the eye or object that can be regarded as eye proximity.

The system control unit 50 can detect the following operations or states based on an output from the gaze detection block 160.

· A new input (detection) of gaze of the user whose eye has come into proximity to the eye proximity unit 16. That is to say, a start of a gaze input.

· A state where the user whose eye has come into proximity to the eye proximity unit 16 is making a gaze input.

· A state where the user whose eye has come into proximity to the eye proximity unit 16 is looking fixedly.

· Cessetion of gaze that has been input by the user whose eye has come into proximity to the eye proximity unit 16. That is to say, an end of a gaze input.

· A state where the user whose eye has come into proximity to the eye proximity unit 16 is not making any gaze input.

The aforementioned fixed look denotes a case where the gaze position of the user has not exceeded a predetermined movement amount within a predetermined time period.

The touch panel 70a and the display unit 28 can be configured integrally. For example, the touch panel 70a is configured so that a light transmittance thereof does not interfere with display of the display unit 28, and is attached to a top layer of a display surface of the display unit 28. Also, input coordinates on the touch panel 70a are associated with display coordinates on the display surface of the display unit 28. This makes it possible to provide a graphical user interface (GUI) via which the user can operate a screen displayed on the display unit 28, as if directly.

The system control unit 50 can detect the following operations or states with respect to the touch panel 70a.

· Newly touching the touch panel 70a with a finger or a stylus that was not touching the touch panel 70a. That is to say, a start of a touch (hereinafter referred to as "touch-down").

· A state where a finger or a stylus is touching the touch panel 70a (hereinafter referred to as "touch-on").

· Movement of a finger or a stylus while it is touching the touch panel 70a (hereinafter referred to as "touch-move").

· Separation of a finger or a stylus that was touching the touch panel 70a from the touch panel 70a. That is to say, an end of a touch (hereinafter referred to as "touch-up").

· A state where nothing is touching the touch panel 70a (hereinafter referred to as "touch-off").

When a touch-down is detected, a touch-on is detected at the same time. After a touch-down, a touch-on normally continues to be detected as long as no touch-up is detected. A touch-move is detected also in a state where a touch-on is detected. Even when a touch-on is detected, a touch-move is not detected as long as a touch position does not move. A touch-off follows the detection of a touch-up of every finger or stylus that was touching.

The system control unit 50 is notified of these operations and states, as well as positional coordinates at which a finger or a stylus is touching the touch panel 70a, via an internal bus. The system control unit 50 judges what kind of operation (touch operation) has been performed on the touch panel 70a based on information of which it has been notified. Regarding a touch-move, a moving direction of a finger or a stylus moving on the touch panel 70a can also be judged for each of a vertical component and a horizontal component on the touch panel 70a based on a change in positional coordinates. It is assumed that, in a case where a touch-move of a predetermined distance or longer has been detected, it is judged that a slide operation has been performed. An operation of quickly moving a finger by some distance while the finger is touching the touch panel and then releasing the finger is called a flick. In other words, a flick is a quick tracing operation involving a swipe of a finger on the touch panel 70a. It can be judged that a flick has been performed when a touch-up is detected immediately after the detection of a touch-move of a predetermined distance or longer at a predetermined speed or faster (it can be judged that a flick has been performed following a slide operation). Furthermore, a touch operation of bringing the touch positions close to each other and a touch operation of moving the touch positions away from each other, while touching a plurality of locations (e.g., two points) at the same time, are referred to as a pinch-in and a pinch-out, respectively. A pinch-out and a pinch-in are collectively referred to as a pinch operation (or simply a pinch). The touch panel 70a may be of any type included among a variety of types of touch panels, such as a resistive film type, a capacitance type, a surface acoustic wave type, an infrared type, an electromagnetic induction type, an image recognition type, and an optical sensor type. Among the variety of types, some types detect a touch on the occurrence of contact with the touch panel, while other types detect a touch when a finger or a stylus has approached the touch panel; either type may be used.

When a touch-move operation has been performed in the eye proximity state, the user can set one of an absolute position designation and a relative position designation as a method of designating a position of a position index in accordance with the touch-move operation. For example, provided that the position index is an AF frame, in the case of the absolute position designation, when the touch panel 70a has been touched, an AF position associated with the touched position (the position of the coordinate input) is set. That is to say, the positional coordinates at which the touch operation was performed are associated with the positional coordinates of the display unit 28. On the other hand, in the case of the relative position designation, the positional coordinates at which the touch operation was performed are not associated with the positional coordinates of the display unit 28. In the case of the relative position designation, regardless of a touch-down position on the touch panel 70a, a touch position is moved from an AF position that is currently set in the moving direction of the touch-move by a distance corresponding to the movement amount of the touch-move.

### External View of Digital Camera

FIG. 2A and FIG. 2B show external views of the digital camera 100 as an example of an apparatus to which the technique according to the present disclosure is applicable. FIG. 2A is a front perspective view of the digital camera 100, and FIG. 2B is a rear perspective view of the digital camera 100. In FIG. 2A and FIG. 2B, the display unit 28 is a display unit provided on a rear surface of the camera, and displays images and various types of information. The touch panel 70a can detect a touch operation on the display surface (operation surface) of the display unit 28. The out-of-viewfinder display unit 43 is a display unit provided on a top surface of the camera, and displays a variety of setting values of the camera, including the shutter speed and the diaphragm. The shutter button 61 is an operation member for issuing an image capturing instruction. The mode changing switch 60 is an operation unit for changing among various types of modes. Terminal covers 40 are covers that guard connectors (not shown) for connecting connection cables intended for external devices and the digital camera 100.

The main electronic dial 71 is a rotary operation member included in the operation unit 70, and rotating this main electronic dial 71 can, for example, change such setting values as the shutter speed and the diaphragm. The power source switch 72 is an operation member that switches between ON and OFF of a power source of the digital camera 100. The sub electronic dial 73 is a rotary operation member included in the operation unit 70, and enables moving of a selection frame, an image jump, and the like. The direction key 74 is a direction-key operation member (a four-direction key) which is included in the operation unit 70, and which has press buttons that can be depressed respectively in four directions in the upper, lower, left, and right portions thereof. It is possible to perform an operation corresponding to the depressed direction, or portion, of the direction key 74. The SET button 75 is a press button included in the operation unit 70, and is mainly used to decide on a selected item, for example. The moving image button 76 is used to issue an instruction for starting and stopping the image capturing (recording) of moving images. The AE lock button 77 is included in the operation unit 70, and can fix an exposure state when depressed in an image capturing standby state. The magnification button 78 is an operation button that is included in the operation unit 70 and is intended to switch between ON and OFF of a magnification mode during live-view display in an image capturing mode. A live-view image can be magnified or reduced by operating the main electronic dial 71 after turning the magnification mode ON. In a reproduction mode, the magnification button 78 functions as a magnification button for magnifying a reproduced image and increasing the magnification rate thereof. The reproduction button 79 is an operation button that is included in the operation unit 70 and switches between an image capturing mode and a reproduction mode. Depressing the reproduction button 79 during an image capturing mode causes a transition to a reproduction mode, and enables the newest image among the images recorded in the recording medium 200 to be displayed on the display unit 28. The menu button 81 is included in the operation unit 70, and when depressed, causes the display unit 28 to display a menu screen on which various types of settings can be configured. A user can intuitively configure various types of settings with use of the menu screen displayed on the display unit 28, the direction key 74, the SET button 75, or the multi-controller (hereinafter, MC) 65.

The AF start button 82 is included in the operation unit 70, and can achieve focus, that is to say, perform a photometric and AF operation, by controlling the diaphragm 1 and displacing the lens 103 as will be described later. The AF start button 82 is structured so that the button is depressed in two steps; a first-step depression operation (hereinafter, half-pressing of the AF start button) and a second-step depression operation that is deeper than the first step (hereinafter, full-pressing of the AF start button) can be performed thereon. By half-pressing and full-pressing the AF start button, not only the photometric and AF operation but also other functions can be actuated, and functions to be actuated can be set by the user on the menu screen.

Similarly to the shutter button 61, the AF start button 82 is a press-button switch including a first switch that is turned ON when half-pressed, and a second switch that is turned ON when fully pressed; half-pressing and full-pressing cause different signals to be input to the system control unit 50. Consequently, the system control unit 50 can judge which one of the half-pressing operation and the full-pressing operation has been performed on the AF start button 82. By using half-pressing and full-pressing of the AF start button 82 separately, the user can cause the digital camera 100 to execute different functions or different types of control. Note that half-pressing is equivalent to an operation over approximately half of the movable range of the AF start button 82 with a press amount that turns the first switch ON, whereas full-pressing is equivalent to an operation over the entirety of the movable range of the AF start button 82 with a press amount that turns the second switch ON. The MC 65 can mainly accept directional instructions in eight directions, and a depression operation on a central portion. The communication terminal 10 is a communication terminal that is intended for the digital camera 100 to communicate with the later-described lens unit 150 (attachable and removable). The eye proximity unit 16 is an eye proximity unit for an eye proximity viewfinder (a look-through viewfinder), and the user can visually recognize a video displayed on the internal electric view finder (EVF) 29 via the eye proximity unit 16. The eye proximity detection unit 57 is an eye proximity detection sensor that detects whether an eye of a photographer is in proximity to the eye proximity unit 16. A cover 202 is a cover for a slot in which the recording medium 200 is contained. A grip unit 90 is a holding unit with a shape that is easily grasped by the right hand while the user is holding the digital camera 100. The shutter button 61 and the main electronic dial 71 are located at positions where they can be operated by the pointing finger of the right hand in a state where the digital camera is held while the grip unit 90 is grasped by the little finger, the ring finger, and the middle finger of the right hand. Furthermore, the sub electronic dial 73 is located at a position where it can be operated by the thumb of the right hand in the same state.

### First Embodiment

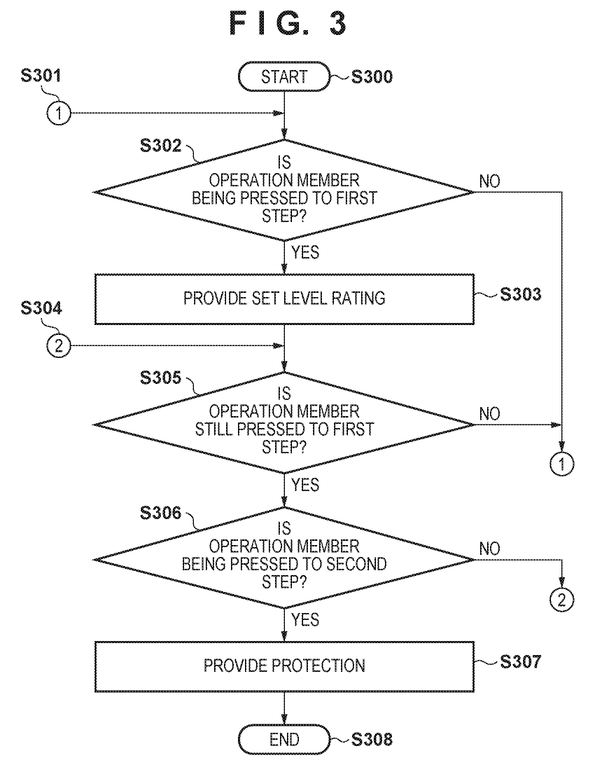

With reference to FIG. 3, the following describes a rating and protection setting method according to the first embodiment of the present disclosure for a case where a half-pressing function and a full-pressing function of the AF start button 82 are fixedly set as a rating function and a protection function, respectively. The present embodiment is an embodiment of the technique according to the present disclosure implemented on the digital camera 100 that has been configured as described using FIG. 1, FIG. 2A, and FIG. 2B. Although the AF start button 82 is a button for performing the photometric and AF operation at the time of image-capturing, another function can be assigned thereto, for example, in a state where captured images are viewed or checked. In view of this, in the present embodiment, the AF start button 82 is assigned for the photometric and AF function at the time of image-capturing, and is assigned for the rating and protection functions for captured image data on other occasions, namely at the time when capturing an image is not performed. The time of image-capturing may be, for example, when live-view display is performed on the display unit 28 or the EVF 29. Alternatively, a state where the reproduction button 79 has been pressed may be the time when image-capturing is not performed. A rating setting is a function of providing a rating level desired by the user to selected image data. A protection setting is a function of providing protection to selected image data and disabling a deletion operation or an update operation therefor, and a function of cancelling protection. A rating level is visually indicated by, for example, a favorite mark corresponding to the rating level. For example, provided that a level from level 0 to level 5 can be provided, a favorite mark corresponding to the magnitude of the level, or the number of favorite marks corresponding to the magnitude of the level, are displayed on an edge portion or outside an image area of a captured image when the captured image is displayed on the display unit 28. Furthermore, with regard to protection as well, a mark indicating whether protection has been provided may be displayed together with the image.

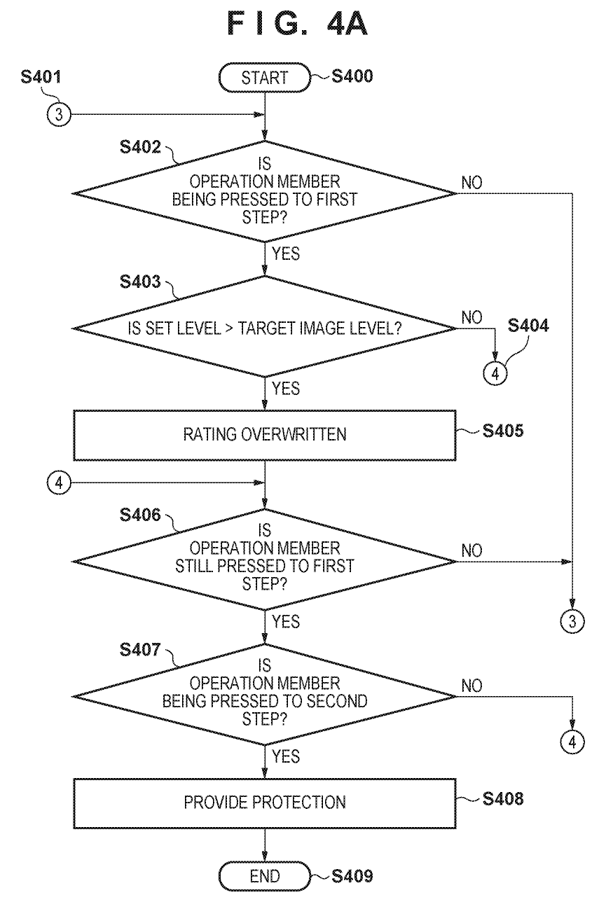

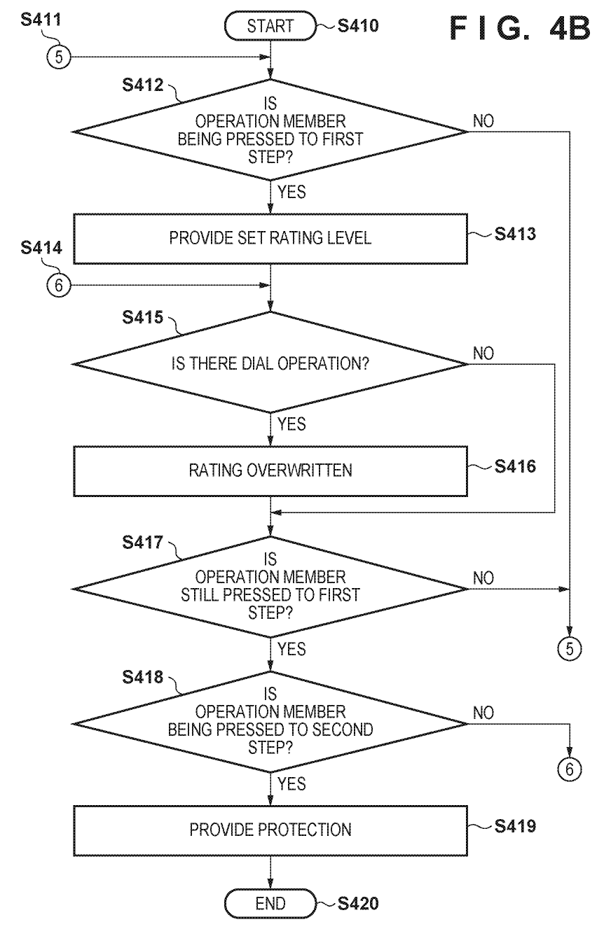

The processing procedure shown in FIG. 3 is realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing. Also, in the figure, circled signs A and B are signs that are referred to only within this figure, and are not referred to across other figures. The same goes for other flowcharts in FIG. 4A and subsequent figures.

Step S300 indicates a start of a state. This is a state where, after a power source switch 204 has been operated with respect to the image capturing apparatus 100 and the image capturing apparatus 100 has been activated, the reproduction button 79 has been depressed, and an image targeted for rating and protection is displayed on a liquid crystal display unit 25. Alternatively this may be a state where, immediately after activating the image capturing apparatus 100 after long-pressing the reproduction button 79, an image targeted for rating and protection is displayed on the liquid crystal display unit 25. Image data corresponding to the displayed image is image data that is targeted for rating and protection; in step S300, the target image data has already been selected. Processing of FIG. 3 is started upon entering this state of step S300. Also, processing of FIG. 3 may be ended upon exiting the state of S300, even in the midst of the processing.

Step S301 is a state immediately after step S300.

In step S302, the system control unit 50 determines whether the operation member has been operated and reached the first step, specifically, whether the AF start button 82 has been half-pressed. In a case where the operation member has been operated and reached the first step, that is to say, half-pressed, processing proceeds to step S303; otherwise, step S302 is repeated via step S301. Note that in the drawings and the following description, the operation member is described as the AF start button 82, and the first step of the operation member is described as half-pressing.

In step S303, in response to half-pressing of the AF start button 82, the system control unit 50 provides a set rating level to the image data. The set rating level may be a rating level that has been set from a non-illustrated setting screen, or may be a rating level of a fixed value that has been decided in advance. Either way, the rating level provided to the target image data in step S303 is a rating level that has already been set at the stage of step S303.

Step S304 is a state immediately after the rating function has been actuated as a result of half-pressing of the AF start button 82.

In step S305, the system control unit 50 determines whether the AF start button 82 has remained to be depressed in the half-pressed state, that is to say, whether the AF start button 82 has been continuously half-pressed from the state where it was determined to be half-pressed in step S302. In a case where it has been half-pressed, processing proceeds to step S306; otherwise, processing proceeds to step S302 via step S301.

In step S306, the system control unit 50 determines whether the operation member has been operated and reached the second step, specifically, whether the AF start button 82 has been fully pressed. In a case where the operation member has been operated and reached the second step, that is to say, fully pressed, processing proceeds to step S307; otherwise, processing proceeds to step S305 via step S304. Note that in the drawings and the following description, the second step of the operation member is described as full-pressing.

In step S307, the system control unit 50 provides protection to the selected image data. Provision of protection may be, for example, setting of protection information indicating that the image data has been protected as an attribute or the like of the image data. At the time of deletion of the image data, it is sufficient that the main executor of deletion processing, such as the system control unit 50, refers to the protection information thereof, and cancels the execution of the deletion if protection has been set therefor. The main executor of the deletion processing may be an information processing apparatus other than the digital camera, such as a PC.

Step S308 indicates an end of a state. This is a state where the AF start button 82 has been fully pressed and both of a rating and protection have been provided to the image.

Note that in a case where full-pressing of the AF start button 82 has been cancelled in step S308, processing may proceed to the state immediately before step S306 and then proceed to step S306 again.

Furthermore, in a case where it has been judged that the state of the AF start button 82 is not half-pressing in step S306, processing may be ended without branching to step S302.

Note that processing of FIG. 3 may be executed in parallel with other types of processing under a multitasking environment. In this way, for example, a loop is formed that returns to step S302 in a case where the AF start button 82 has been half-pressed but the operation thereon has been aborted without fully pressing the AF start button 82; in this case, too, other types of processing, such as processing for re-selection and capturing of target image data, can be executed. The same goes for flowcharts according to other embodiments. Alternatively, for example, even if the multitasking environment does not exist, coexistence with other types of processing is made possible by making the judgment of step S302 within processing for testing an input and branching to processing corresponding to the input (idle processing). In this case, it is permissible to adopt a configuration for branching to step S303 when it is determined that the condition of step S302 is satisfied within the idle processing, or it is permissible to branch back to the idle processing instead of branching to step S302 in step S305. With this configuration, even if the multitasking environment does not exist, other types of processing, such as processing for re-selection and capturing of target image data, can be executed. The same goes for other embodiments.

Rating and protection operations can be performed with respect to captured image data by re-selecting new image data from among pieces of captured image data, regarding the new image data as new target image data, and executing processing of FIG. 3 therefor.

In the present embodiment, regardless of whether a rating and protection have been provided to a target image, a specific rating level that has been set is provided by half-pressing the AF start button 82, and protection is provided by fully pressing the AF start button 82. That is to say, the user can operate one operation member and provide a rating level to target image data, or set protection in addition to provision of the rating level, in accordance with the manner or the extent of this operation. Accordingly, the cumbersomeness of the operation of providing both of a rating and protection to an image can be reduced. This improves the operability of the digital camera, and also renders the task of setting a rating and protection for image data efficient.

Note that, in the present embodiment, half-pressing and full-pressing of the AF start button 82 that can be operated in two steps are assigned to rating and protection; however, two steps of a switch, such as a button, that can be operated in more than two steps on a per-step basis may be assigned to rating and protection. The same goes for other embodiments.

### Second Embodiment

With reference to FIG. 4A, the following describes a rating and protection setting method according to a second embodiment of the present disclosure for a case where a half-pressing function and a full-pressing function of the AF start button 82 are fixedly set as a rating function and a protection function, respectively. In the first embodiment, a predetermined rating level that has been set is provided to target image data in response to a rating operation. In contrast, in the present embodiment, if a predetermined rating level is higher than a rating level that has already been provided to target image data, the predetermined rating level is provided, but otherwise, the rating level that has already been provided is not updated. That is to say, in the present embodiment, among the predetermined rating level and the rating level that has already been provided, a higher rating level is provided to a target image in response to a rating operation. The present embodiment differs from the first embodiment in this regard.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment.

The processing procedure shown in FIG. 4A is realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing. Also, in the figure, circled signs A and B are signs that are referred to only within this figure, and are not referred to across other figures.

Step S400 indicates the same state as step S300. Processing of FIG. 4A is started in this state. Target image data that is targeted for an operation at this time has already been selected, and is displayed as an image on the liquid crystal display unit 25. Processing of FIG. 4A is started upon entering this state of step S400. Also, processing of FIG. 4A may be ended upon exiting the state of S400, even in the midst of the processing.

Step S401 indicates the same state as step S301.

In step S402, the system control unit 50 determines whether the AF start button 82 is half-pressed. In a case where it is half-pressed, processing proceeds to step S403; otherwise, processing proceeds to step S402 via step S401.

In step S403, the system control unit 50 determines whether a rating level to be provided in response to half-pressing of the AF start button 82 is higher than a rating level that has been provided to image data corresponding to the image displayed on the liquid crystal display unit 25, that is to say, target image data. If the former is higher than the latter, processing proceeds to step S405; otherwise, processing proceeds to step S406 via step S404. A rating level is presented as, for example, the number of start-shaped marks on a displayed image; as an example, the lowest level is 0 and the highest level is 5, and the rating level is indicated by an integer in that range.

Step S404 is a state immediately after the rating function has been actuated as a result of half-pressing of the AF start button 82.

In step S405, the system control unit 50 provides a rating level to the target image data as a result of half-pressing of the AF start button 82. That is to say, the system control unit 50 overwrites the rating level that has already been provided to the target image data using the set rating level. The set rating level is a rating level similar to that of the first embodiment.

In step S406, the system control unit 50 determines whether the AF start button 82 has been continuously half-pressed. In a case where it has been half-pressed, processing proceeds to step S407; otherwise, processing proceeds to step S402 via step S401.

In step S407, the system control unit 50 determines whether the AF start button 82 is fully pressed. In a case where it is fully pressed, processing proceeds to step S408; otherwise, processing proceeds to step S406 via step S404.

In step S408, the system control unit 50 provides protection to the selected image data. This is similar to step S307 of the first embodiment.

Step S409 indicates an end of a state. This is a state where the AF start button 82 has been fully pressed and both of the rating and protection functions have been actuated.

Note that in a case where full-pressing of the AF start button 82 has been cancelled in step S409, processing may proceed to the state immediately before step S407 and then proceed to step S407 again.

Rating and protection operations can be performed with respect to captured image data by re-selecting new image data from among pieces of captured image data, regarding the new image data as new target image data, and executing processing of FIG. 4A therefor.

In the present embodiment, a judgment is made about whether a rating level to be provided in response to half-pressing of the AF start button 82 is higher than a rating level that has been provided to an image displayed on the liquid crystal display unit 25, and protection is provided in response to full-pressing of the AF start button 82. That is to say, the user can operate one operation member and provide a rating level to target image data, or set protection in addition to provision of the rating level, in accordance with the manner or the extent of this operation. In addition, as a level lower than a rating level that has already been provided is not provided, it is possible to prevent a low rating level from being provided to target image data against the user's intention. Note that with respect to image data immediately after image capturing, a predetermined rating level, such as level 0, may be provided and stored. In this way, the cumbersomeness of the operation of providing protection to image data of a rating equal to or higher than a specific level can be reduced. This improves the operability of the digital camera, and also renders the task of setting a rating and protection for image data efficient. Furthermore, image data that already has a rating level equal to or higher than a specific level does not require the trouble of newly setting a rating level after protection has been provided; in this regard, too, the task of setting a rating and protection is rendered efficient.

### Third Embodiment

With reference to FIG. 4B, the following describes a rating and protection setting method according to a third embodiment of the present disclosure for a case where a half-pressing function and a full-pressing function of the AF start button 82 are fixedly set as a rating function and a protection function, respectively. In the second embodiment, if a predetermined rating level that has been set is higher than a rating level that has already been provided, the predetermined rating level is provided to target image data in response to a rating operation. In contrast, in the present embodiment, a user can change a rating level to be provided at the time of a rating providing operation. The present embodiment differs from the first and second embodiments in this regard.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment.

The processing procedure shown in FIG. 4B is realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing. Also, in the figure, circled signs A and B are signs that are referred to only within this figure, and are not referred to across other figures.

Step S410 indicates the same state as step S300. Processing of FIG. 4B is started in this state. Target image data that is targeted for an operation at this time has already been selected, and is displayed as an image on the liquid crystal display unit 25. Processing of FIG. 4A is started upon entering this state of step S410. Also, processing of FIG. 4A may be ended upon exiting the state of S410, even in the midst of the processing.

Step S411 indicates the same state as step S301.

In step S412, the system control unit 50 determines whether the AF start button 82 is half-pressed. In a case where it is half-pressed, processing proceeds to step S413; otherwise, processing proceeds to step S412 via step S411.

In step S413, in response to half-pressing of the AF start button 82, the system control unit 50 provides a set rating level to the target image data. Here, the set rating level may be a rating level that has been set in advance, similarly to the first embodiment.

Step S414 is a state immediately after the rating function has been actuated as a result of half-pressing of the AF start button 82.

In step S415, the system control unit 50 determines whether another member, such as a dial, has been operated while the AF start button 82 remains to be half-pressed immediately after the rating function has been actuated by half-pressing of the AF start button 82. If the dial operation has been performed, processing proceeds to step S416; otherwise, processing proceeds to step S417. Here, the operated dial may be the main electronic dial 71, the sub electronic dial 73, or another dial, but is preferably a dial that is easily operated while half-pressing the AF start button 82, such as the main electronic dial 71.

In step S416, the system control unit 50 decides a rating level in accordance with, for example, an operation amount, an operation direction, and the like of the dial that has been judged to be operated in step S415, and overwrites a rating level that has already been provided to the target image data using the decided rating level. For example, the predetermined rating level that has been provided in step S413 is used as a base, and the rating level is incremented by one when, for example, a rotation operation of a predetermined direction and a predetermined angle has been performed on the dial. Also, the rating level is decremented by one when a rotation operation of a direction opposite to the predetermined direction and the predetermined angle has been performed on the dial. However, if an upper limit and a lower limit are provided for the rating level, the rating level may not be changed even if an operation that exceeds these limits has been performed. Although this is an example, the rating level may be decided in this way.

In step S417, the system control unit 50 determines whether the AF start button 82 has been continuously half-pressed. In a case where it has been half-pressed, processing proceeds to step S418; otherwise, processing proceeds to step S412 via step S411.

In step S418, the system control unit 50 determines whether the AF start button 82 is fully pressed. In a case where it is fully pressed, processing proceeds to step S419; otherwise, processing proceeds to step S415 via step S414.

In step S419, the system control unit 50 provides protection to the target image data. This is similar to step S307 of the first embodiment.

Step S420 indicates an end of a state. This is a state where the AF start button 82 has been fully pressed and both of the rating and protection functions have been actuated.

Note that in a case where full-pressing of the AF start button 82 has been cancelled in step S420, processing may proceed to the state immediately before step S414 and then proceed to step S414 again.

Rating and protection operations can be performed with respect to captured image data by re-selecting new image data from among pieces of captured image data, regarding the new image data as new target image data, and executing processing of FIG. 4B therefor.

In the present embodiment, after a rating of a specific level has been provided in response to half-pressing of the AF start button 82, if a dial operation for changing the rating level has been performed while half-pressing the AF start button 82, the rating level is overwritten. Furthermore, protection is provided in response to full-pressing of the AF start button 82.

In this way, the user can provide any rating to image data. Also, the cumbersomeness of the operation of providing protection to this image data to which the rating has been provided can be reduced. This improves the operability of the digital camera, and also renders the task of setting a rating and protection for image data efficient. Furthermore, as the rating level can also be set at the time of this provision, the trouble of newly adjusting the rating level is eliminated; in this regard, too, the task of setting a rating and protection is rendered efficient.

### Fourth Embodiment

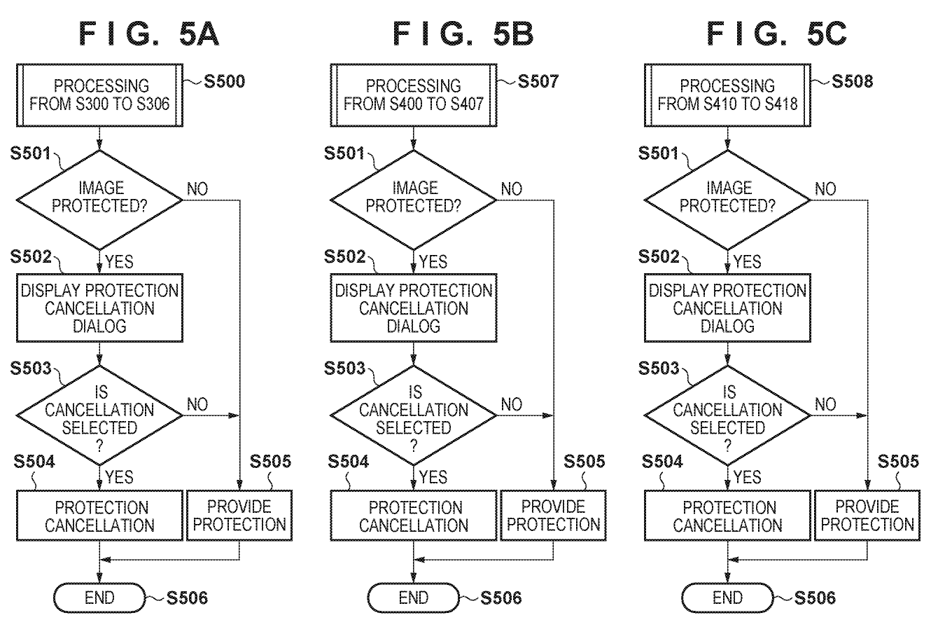

With reference to FIG. 5A–FIG. 5C, the following describes a rating and protection setting method and a protection cancellation method according to a fourth embodiment of the present disclosure for a case where a half-pressing function and a full-pressing function of the AF start button 82 are fixedly set as a rating function and a protection function, respectively.

In FIG. 5A, FIG. 3 is referred to in setting of a rating. That is to say, setting of a rating is configured with respect to target image data in steps S300 to S306 of FIG. 3, which have been described in the first embodiment, and in a case where it has been judged that the operation member, namely the AF start button 82, has been fully pressed in step S306, setting of protection is configured in steps S501 to S506 of FIG. 5A. In the present embodiment, a full-pressing operation on the AF start button 82 can not only set protection, but also cancel protection that has already been set.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment. The processing procedures shown in FIG. 5A–FIG. 5C are realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing.

Step S500 is processing that is the same as steps S300 to S306 of FIG. 3. In a case where it has been judged that the AF start button 82 is fully pressed in step S306, processing proceeds to step S501.

In step S501, the system control unit 50 determines whether protection has already been provided to the target image data. In a case where protection is given by setting protection information, which indicates that the target image data has been protected, as, for example, attribute information of the target image data, the determination of step S501 can be made by referring to this protection information. If protection has been provided, processing proceeds to step S502; otherwise, processing proceeds to step S505.

In step S502, the system control unit 50 causes, for example, the display unit 28 to display a dialog of protection cancellation.

In step S503, the system control unit 50 judges whether cancellation of protection has been selected, that is to say, whether a cancellation operation has been performed. Cancellation of protection may be performed as follows, for example: an operation unit for a cancellation operation is displayed on the dialog displayed in step S502, and a user operates, for example, touches, an area corresponding to this operation unit on the touch panel 70a. In this case, an operation unit for maintaining protection without cancelling protection may also be displayed on the dialog, and the user may perform an operation for not cancelling protection by operating, for example, touching, an area corresponding to this operation unit on the touch panel 70a. In this case, if the operation for not cancelling protection is performed, it can be judged that cancellation has not been selected in step S503. The operations for cancelling and maintaining protection may be performed using other operation units, such as buttons and a dial. In a case where buttons are used, a cancelling button and a maintaining button are prepared, and the judgment of step S503 is made by judging which one of the buttons has been operated. For example, in a case where a dial is used, whether protection is to be cancelled or maintained may be judged in accordance with a direction in which the dial has been rotated. In a case where cancellation of protection has been selected in step S503, processing proceeds to step S504; otherwise, processing proceeds to step S505.

In step S504, the system control unit 50 cancels protection on the target image data. Cancellation of protection may be performed by, for example, rewriting information indicating protection, which has been provided as attribute information of the target image data, to information indicating that the target image data is not protected.

In step S505, the system control unit 50 provides protection to the target image data. This step is similar to step S307.

Step S506 indicates an end of a state. This is a state where the AF start button 82 has been fully pressed and both of the rating and protection functions have been actuated.

Note that in a case where full-pressing of the AF start button 82 has been cancelled in step S506, processing may proceed to the state immediately before step S501 and then proceed to step S501 again.

Rating and protection operations (setting and cancellation) can be performed with respect to captured image data by re-selecting new image data from among pieces of captured image data, regarding the new image data as new target image data, and executing processing of FIG. 5A therefor.

In FIG. 5B, setting of a rating is configured through the procedure shown in FIG. 4A. Step S507 is processing that is the same as steps S400 to S407 of FIG. 4A. In a case where it has been judged that the AF start button 82 is fully pressed in step S407, processing branches to step S501. Step S501 and subsequent steps are similar to those of FIG. 5A.

Rating and protection operations can be performed with respect to captured image data by re-selecting new image data from among pieces of captured image data, regarding the new image data as new target image data, and executing processing of FIG. 5B therefor.

In FIG. 5C, setting of a rating is configured through the procedure shown in FIG. 4B. Step S508 is processing that is the same as steps S410 to S418 of FIG. 4B. In a case where it has been judged that the AF start button 82 is fully pressed in step S418, processing branches to step S501. Step S501 and subsequent steps are similar to those of FIG. 5A.

Rating and protection operations can be performed with respect to captured image data by re-selecting new image data from among pieces of captured image data, regarding the new image data as new target image data, and executing processing of FIG. 5C therefor.

As in the present embodiment, in a case where the protection function is actuated by full-pressing of the AF activation button 82, that is to say, in a case where the protection function is actuated by operating the operation member until the second step is reached, the cumbersomeness of the operation of providing protection to a rated image can be reduced.

Furthermore, by increasing steps for selecting cancellation of protection on a dialog in a case where the protection function has been actuated with respect to an image to which protection has been provided, it is possible to prevent protection on an image that should be protected from being cancelled by error. Erroneous erasure of an image caused by unprovided protection can be prevented.

Note that although steps for cancelling protection are increased on purpose in the present embodiment, it is also possible to improve operability by reducing these steps by omitting steps S502 and S503. In this way, setting of protection on image data is configured so that protection is cancelled with respect to image data to which protection has already been provided, and protection is provided to image data to which protection has not been provided yet; as a result, operations are simplified. As there is a trade-off between this and the above-described prevention of erroneous erasure, it is permissible to adopt a configuration that allows the user to select whether to perform steps S502 and S503 by way of a setting that is separately provided.

### Fifth Embodiment

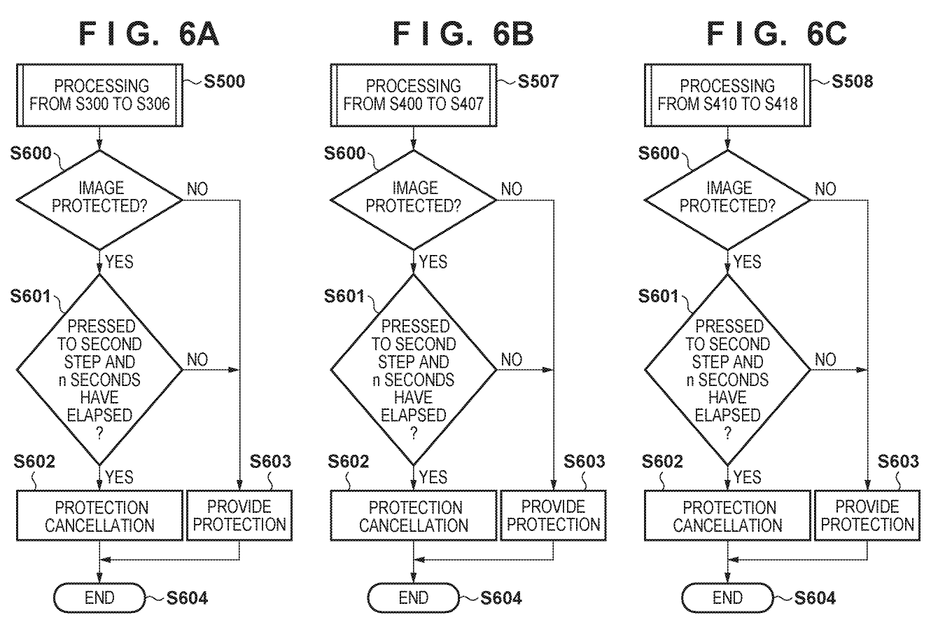

With reference to FIG. 6A–FIG. 6C, the following describes a rating and protection setting method and a protection cancellation method according to a fifth embodiment of the present disclosure for a case where a half-pressing function and a full-pressing function of the AF start button 82 are fixedly set as a rating function and a protection function, respectively.

In FIG. 6A, FIG. 3 is referred to in setting of a rating. That is to say, setting of a rating is configured with respect to target image data in steps S300 to S306 of FIG. 3, which have been described in the first embodiment, and in a case where it has been judged that the operation member, namely the AF start button 82, has been fully pressed in step S306, setting of protection is configured in steps S600 to S604 of FIG. 6A. In the present embodiment, a full-pressing operation on the AF start button 82 can not only set protection, but also cancel protection that has already been set. The difference from the fourth embodiment is that, in the present embodiment, it is possible to select cancellation of protection using the operation member, namely the AF start button 82, as opposed to the fourth embodiment in which cancellation of protection is selected from a dialog.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment. The processing procedures shown in FIG. 6A–FIG. 6C are realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing.

Step S500 is processing that is the same as steps S300 to S306 of FIG. 3. In a case where it has been judged that the AF start button 82 is fully pressed in step S306, processing proceeds to step S600.

In step S600, the system control unit 50 determines whether protection has already been provided to the target image data. Step S600 is similar to step S501 of the fourth embodiment. If protection has been provided, processing proceeds to step S601; otherwise, processing proceeds to step S603.

In step S601, the system control unit 50 determines whether the AF start button 82 has been fully depressed for a certain period after being half-pressed, that is to say, whether a second-step operation has been performed thereon continuously for a predetermined period after a first-step operation. In step S601, for example, the system control unit 50 may activate the system timer 53 upon receiving a signal equivalent to full-pressing from the AF start button 82, and determine that the AF start button 82 has been depressed for the certain period when an elapsed period that has been measured since this activation reaches the certain period. In a case where it has been judged that the certain period has elapsed in step S601, processing proceeds to step S602; otherwise, processing proceeds to step S603.

In step S602, the system control unit 50 cancels protection on the target image data. This is similar to step S504 of FIG. 5A–FIG. 5C.

In step S603, the system control unit 50 provides protection to the target image data. This is similar to step S505 of FIG. 5A–FIG. 5C.

Step S604 indicates an end of a state. This is a state where the AF start button 82 has been fully pressed and both of the rating and protection functions have been actuated.

Note that in a case where full-pressing of the AF start button 82 has been cancelled in step S604, processing may proceed to the state immediately before step S600 and then proceed to step S600 again.

Rating and protection operations (setting and cancellation) can be performed with respect to captured image data by re-selecting new image data from among pieces of captured image data, regarding the new image data as new target image data, and executing processing of FIG. 6A therefor.

In FIG. 6B, setting of a rating is configured through the procedure shown in FIG. 4A. Step S507 is processing that is the same as steps S400 to S407 of FIG. 4A. In a case where it has been judged that the AF start button 82 is fully pressed in step S407, processing branches to step S600. Step S600 and subsequent steps are similar to those of FIG. 6A.

Rating and protection operations can be performed with respect to captured image data by re-selecting new image data from among pieces of captured image data, regarding the new image data as new target image data, and executing processing of FIG. 6B therefor.

In FIG. 6C, setting of a rating is configured through the procedure shown in FIG. 4B. Step S508 is processing that is the same as steps S410 to S418 of FIG. 4B. In a case where it has been judged that the AF start button 82 is fully pressed in step S418, processing branches to step S600. Step S600 and subsequent steps are similar to those of FIG. 6A.

Rating and protection operations can be performed with respect to captured image data by re-selecting new image data from among pieces of captured image data, regarding the new image data as new target image data, and executing processing of FIG. 6C therefor.

As in the present embodiment, in a case where the protection function is actuated by full-pressing of the AF activation button 82, that is to say, in a case where the protection function is actuated by operating the operation member until the second step is reached, the cumbersomeness of the operation of providing protection to a rated image can be reduced.

Furthermore, by increasing steps for holding a full-pressing operation in a case where the protection function has been actuated with respect to an image to which protection has been provided, the effort required in an operation for protection and an operation for cancelling the protection can be alleviated. Therefore, erroneous erasure of an image caused by unprovided protection can be prevented.

### Sixth Embodiment

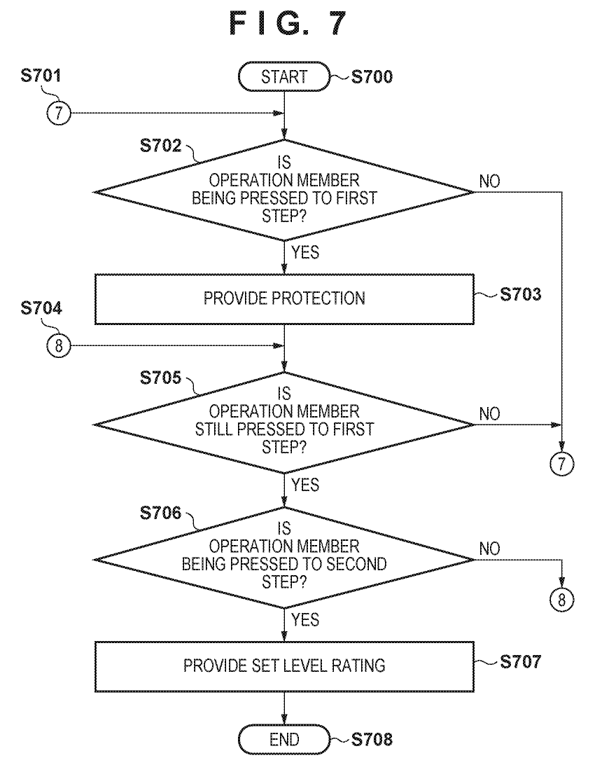

With reference to FIG. 7, the following describes a rating and protection setting method according to a sixth embodiment of the present disclosure for a case where a half-pressing function and a full-pressing function of the AF start button 82 are fixedly set as a rating function and a protection function, respectively. The present embodiment differs from the first to fifth embodiments in that the function corresponding to the first-step (half-pressing) operation on the operation member and the function corresponding to the second-step (full-pressing) operation thereon are replaced with each other.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment. The processing procedure shown in FIG. 7 is realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing.

Step S700 indicates a start of a state. This is the same state as step S300 of FIG. 3. Processing of FIG. 7 is started in this state. Target image data that is targeted for an operation at this time has already been selected, and is displayed as an image on the liquid crystal display unit 25. Processing of FIG. 7 is started upon entering this state of step S700. Also, processing of FIG. 7 may be ended upon exiting the state of S700, even in the midst of the processing.

Step S701 is a state immediately after step S700.

In step S702, the system control unit 50 determines whether the AF start button 82 is half-pressed. In a case where it is half-pressed, processing proceeds to step S703; otherwise, processing proceeds to step S702 via step S701.

In step S703, the system control unit 50 provides protection to the target image data. This is similar to step S307 of FIG. 3.

Step S704 is a state immediately after the protection function has been actuated as a result of half-pressing of the AF start button 82.

In step S705, the system control unit 50 determines whether the AF start button 82 has been continuously half-pressed. In a case where it has been half-pressed, processing proceeds to step S706; otherwise, processing proceeds to step S702 via step S701.

In step S706, the system control unit 50 determines whether the AF start button 82 is fully pressed. In a case where it is fully pressed, processing proceeds to step S707; otherwise, processing proceeds to step S705 via step S704.

In step S707, in response to full-pressing of the AF start button 82, the system control unit 50 provides a set rating level to the target image data.

Step S708 indicates an end of a state. This is a state where the AF start button 82 has been fully pressed and both of a rating and protection have been provided to the image.

Note that in a case where full-pressing of the AF start button 82 has been cancelled in step S708, processing may proceed to the state immediately before step S706 and then proceed to step S706 again.

Protection and rating operations can be performed with respect to captured image data by re-selecting new image data from among pieces of captured image data, regarding the new image data as new target image data, and executing processing of FIG. 7 therefor.

In the present embodiment, regardless of whether a rating and protection have been provided to a target image, protection is provided by half-pressing the AF start button 82, and a specific rating level that has been set is provided by fully pressing the AF start button 82. That is to say, setting of protection on the image data can be configured by the first-step operation on the operation member, and setting of a rating of the image data can be configured by the second-step operation thereon.

Accordingly, the cumbersomeness of the operation of providing both of a rating and protection to an image can be reduced.

Note that in the present embodiment, regarding setting of protection, protection is provided by half-pressing of the AF start button 82. Regarding this, with respect to image data to which protection has already been provided, protection may be cancelled in the manner that has been described in the fourth embodiment or the fifth embodiment. That is to say, when the operation of setting of protection has been performed by half-pressing the AF start button 82, if protection has already been provided to the target image data, protection is cancelled. Alternatively, if protection has already been provided to the target image data, protection is cancelled in response to a cancellation instruction on a dialog, or holding of half-pressing of the AF start button 82 (a half-pressing operation that has continued for a predetermined period). In this way, setting of a rating can be configured, together with provision or cancellation of protection on the target image data, by operating the AF start button 82.

### Seventh Embodiment

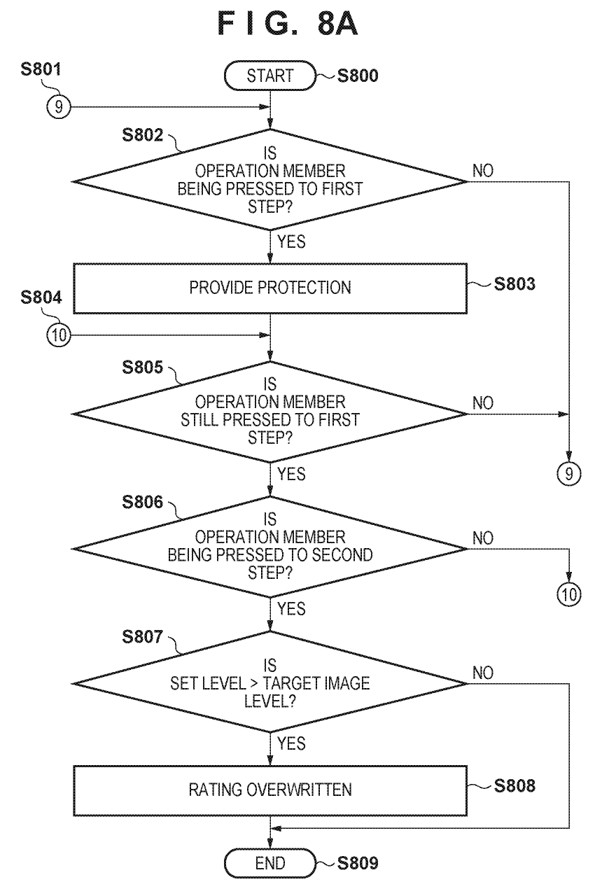

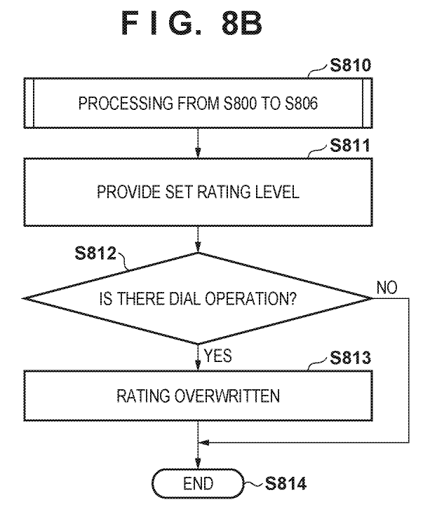

With reference to FIG. 8A, the following describes a rating and protection setting method according to a seventh embodiment of the present disclosure for a case where a half-pressing function and a full-pressing function of the AF start button 82 are fixedly set as a rating function and a protection function, respectively. In the sixth embodiment, a rating level to be set is a higher rating level among a predetermined level and a level that has already been provided to target image data. The present embodiment differs from the sixth embodiment in this regard.

The present embodiment is an embodiment of the technique according to the present disclosure implemented on the digital camera 100 that has been configured as described using FIG. 1, FIG. 2A, and FIG. 2B. The AF start button 82 is configured in the same manner as in the first embodiment. The processing procedures shown in FIG. 8A and FIG. 8B are realized by the system control unit 50 of the digital camera 100, especially a processor (or CPU) included therein, executing a program that has been read out from the nonvolatile memory 56 and loaded to the system memory 52. That is to say, the system control unit 50, especially the processor included therein, is the main executor of the processing. The same goes for FIG. 6B and FIG. 6C.

Step S800 indicates a start of a state. This is the same state as step S300 of FIG. 3. Processing of FIG. 8A is started in this state. Target image data that is targeted for an operation at this time has already been selected, and is displayed as an image on the liquid crystal display unit 25. Processing of FIG. 8A is started upon entering this state of step S800. Also, processing of FIG. 8A may be ended upon exiting the state of S800, even in the midst of the processing.

Step S801 is a state immediately after step S800.

In step S802, the system control unit 50 determines whether the AF start button 82 is half-pressed. In a case where it is half-pressed, processing proceeds to step S803; otherwise, processing proceeds to step S802 via step S801.

In step S803, the system control unit 50 provides protection to the target image data. This is similar to step S307.

Step S804 is a state immediately after the protection function has been actuated as a result of half-pressing of the AF start button 82.

In step S805, the system control unit 50 determines whether the AF start button 82 has been continuously half-pressed. In a case where it has been half-pressed, processing proceeds to step S806; otherwise, processing proceeds to step S802 via step S801.

In step S806, the system control unit 50 determines whether the AF start button 82 is fully pressed. In a case where it is fully pressed, processing proceeds to step S807; otherwise, processing proceeds to step S805 via step S804.

In step S807, the system control unit 50 determines whether a predetermined rating level to be provided in response to full-pressing of the AF start button 82 is higher than a rating level that has been provided to the image displayed on the liquid crystal display unit 25, that is to say, the target image data. If the former is larger than the latter, processing proceeds to step S808; otherwise, processing proceeds to step S809 and is ended. Here, the predetermined rating level may be a fixed level, or may be a rating level that has been set in advance by a user.

In step S808, the system control unit 50 overwrites the rating level of the captured image using the predetermined rating level to be provided in response to full-pressing of the AF start button 82.

Step S809 indicates an end of a state. This is a state where the AF start button 82 has been fully pressed and both of a rating and protection have been provided to the image.

Note that in a case where full-pressing of the AF start button 82 has been cancelled in step S808, processing may proceed to the state immediately before step S806 and then proceed to step S806 again.

Protection and rating operations can be performed with respect to captured image data by re-selecting new image data from among pieces of captured image data, regarding the new image data as new target image data, and executing processing of FIG. 8A therefor.

In the present embodiment, protection is provided in response to half-pressing of the AF start button 82, and a judgment is made about whether a predetermined rating level to be provided in response to full-pressing of the AF start button 82 is higher than a rating level that has already been provided to the target image data. Then, if the predetermined rating level is higher, the predetermined rating level is provided to the target image data.

This can reduce the cumbersomeness of the operation of providing a rating equal to or higher than a specific level to an image to which protection has been provided.

Note that in the present embodiment, regarding setting of protection, protection is provided by half-pressing of the AF start button 82. Regarding this, with respect to image data to which protection has already been provided, protection may be cancelled in the manner that has been described in the fourth embodiment or the fifth embodiment. That is to say, when the operation of setting of protection has been performed by half-pressing the AF start button 82, if protection has already been provided to the target image data, protection is cancelled. Alternatively, if protection has already been provided to the target image data, protection is cancelled in response to a cancellation instruction on a dialog, or holding of half-pressing of the AF start button 82 (a half-pressing operation that has continued for a predetermined period). In this way, setting of a rating can be configured, together with provision or cancellation of protection on the target image data, by operating the AF start button 82. Regarding protection setting processing, the same goes for an eighth embodiment, which has common points with the present embodiment.

### Eighth Embodiment

With reference to FIG. 8B, the following describes a rating and protection setting method according to an eighth embodiment of the present disclosure for a case where a half-pressing function and a full-pressing function of the AF start button 82 are fixedly set as a rating function and a protection function, respectively. In the seventh embodiment, a rating level to be set is a higher rating level among a predetermined level and a level that has already been provided to target image data. In contrast, in the present embodiment, a user can designate a rating level at the time of setting of a rating level. The present embodiment differs from the seventh embodiment in this regard.

Step S810 represents processing from step S800 to step S806. That is to say, in the present embodiment, steps S800–S806 are executed in a manner similar to the seventh embodiment.

In step S811, in response to half-pressing of the AF start button 82, the system control unit 50 provides a set rating level to an image. Here, the provided rating level may be a fixed level, or may be a level that has been set in advance by the user, similarly to the seventh embodiment.

In step S812, the system control unit 50 determines whether another member, such as a dial, has been operated while the AF start button 82 remains to be half-pressed immediately after the rating function has been actuated by half-pressing of the AF start button 82. If the operation has been performed, processing proceeds to step S813; otherwise, processing proceeds to step S814.

In step S813, the system control unit 50 decides a rating level corresponding to the dial operation, and overwrites the rating level of the target image data using the decided rating level. The rating level corresponding to the dial operation may be decided in a manner similar to step S416 of FIG. 4B.

Step S814 indicates an end of a state. This is a state where the AF start button 82 has been fully pressed and both of the rating and protection functions have been actuated.

Note that in a case where full-pressing of the AF start button 82 has been cancelled in step S814, processing may proceed to the state immediately before step S812 and then proceed to step S812 again.

Protection and rating operations can be performed with respect to captured image data by re-selecting new image data from among pieces of captured image data, regarding the new image data as new target image data, and executing processing of FIG. 8B therefor.

In the present embodiment, after protection has been provided by half-pressing of the AF start button 82, a set rating is provided by full-pressing of the AF start button 82. Then, if a dial operation for changing the rating level has been performed during the full-pressing, the rating level can be overwritten in accordance with the operation.

This can reduce the cumbersomeness of the user's operation of providing a rating of an arbitrary level to an image to which protection has been provided. That is to say, the operability of the digital camera can be improved.

### Ninth Embodiment

In a case where the AF start button 82 has been assigned functions for the time of reproduction, such as a rating and protection, it is possible to transition to an image capturing state in response to depression of a release button 201 by assigning only an image capturing function to a first step of the release button 201.

### Tenth Embodiment

It is possible to adopt a configuration in which the functions that are assigned to the first step and the second step of the operation member are interchangeable. For example, an item for selecting whether to assign setting of a rating level or assign setting of protection to the half-pressing operation on the AF start button is added to a menu for setting the digital camera. Once the assignment of a function corresponding to one operation has been decided, a function corresponding to the other operation is also decided. The selected setting is saved. Then, if setting of a rating level has been assigned to the half-pressing operation on the AF start button in accordance with the setting value of this item, setting of protection is assigned to the full-pressing operation on the AF start button. On the other hand, if setting of protection has been assigned to the half-pressing operation on the AF start button, setting of a rating level is assigned to the full-pressing operation on the AF start button.

Then, the saved setting is referred to upon entering the state that has been described using step S300, for example. In a case where setting of a rating level and setting of protection have been assigned to the half-pressing operation and the full-pressing operation on the AF start button, respectively, one of the first embodiment to the fifth embodiment is implemented. On the other hand, in a case where setting of protection and setting of a rating level have been assigned to the half-pressing operation and the full-pressing operation on the AF start button, respectively, one of the sixth embodiment to the eighth embodiment is implemented.

In this way, flexibility in assignment of functions to operations is improved, and the operability can be further improved for a user.

### Other Embodiments

Embodiment(s) of the present invention can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189196, filed October 28, 2024 which is hereby incorporated by reference herein in its entirety.

What is claimed is:

1. An image capturing apparatus, comprising:
a first operation member that has a structure for operations in respective steps that include a first step and a second step;
at least one memory storing instructions; and
at least one processor that is in communication with the at least one memory and that, when executing the instructions, cooperates with the at least one memory to execute processing, the processing including
executing first processing with respect to target image data in response to the operation in the first step on the first operation member, and
executing second processing with respect to the target image data in response to the operation in the second step on the first operation member,
wherein the first processing is processing for performing one of rating setting and protection setting with respect to the target image data, and the second processing is processing for performing another one of the rating setting and the protection setting.

2. The image capturing apparatus according to claim 1, wherein
the first processing is rating processing for setting a rating for the target image data, and the second processing is protection processing for setting protection on the target image data.

3. The image capturing apparatus according to claim 2, wherein
in the rating processing, a rating level that has been set in advance is provided.

4. The image capturing apparatus according to claim 2, wherein
in the rating processing, in a case where a rating level has not been provided to the target image data yet, a rating level that has been decided in advance is provided, and in a case where a rating level has already been provided to the target image data, a rating level that is different from the provided rating level is provided.

5. The image capturing apparatus according to claim 4, wherein
in the rating processing, in a case where a rating level that has been set in advance is higher than a rating level that has been provided to the target image data, the rating level that has been set in advance is provided to the target image data, and in other cases, the rating level that has been provided to the target image data is maintained.

6. The image capturing apparatus according to claim 2, further comprising
a second operation member,
wherein in the rating processing, a rating level that has been set by the second operation member is provided to the target image data.

7. The image capturing apparatus according to claim 6, wherein
setting of a rating level by the second operation member is executable at a time of the rating processing.

8. The image capturing apparatus according to claim 1, wherein
in the protection processing, in a case where protection has not been provided to the target image data, protection is provided to the target image data.

9. The image capturing apparatus according to claim 8, wherein
in the protection processing, in a case where protection has been provided to the target image data, the protection on the target image data is cancelled.

10. The image capturing apparatus according to claim 8, further comprising
a third operation member,
wherein the processing includes, in the protection processing, causing a display indicating cancellation of protection to be displayed on a display unit in a case where the protection has been provided to the target image data, and cancelling the protection on the target image data in a case where cancellation of the protection has been selected by the third operation member during the display indicating cancellation of the protection.

11. The image capturing apparatus according to claim 8, wherein
in the protection processing, in a case where a predetermined operation has been performed by the first operation member in a state where protection has been provided to the target image data, the protection on the target image data is cancelled.

12. The image capturing apparatus according to claim 11, wherein
the predetermined operation is continuation of the operation in the second step on the first operation member for a predetermined period.

13. The image capturing apparatus according to claim 3, further comprising
a display that displays the target image data as an image,
wherein a rating level provided through the rating setting is indicated by a favorite mark corresponding to the rating level on the display.

14. The image capturing apparatus according to claim 2, wherein
the first operation member is a press button switch that accepts a depression operation, the first step is half-pressing of the press button switch, and the second step is full-pressing of the press button switch.

15. The image capturing apparatus according to claim 1, further comprising:
a image capturing unit that captures an image; and
a storage in which image data of the image captured by the image capturing unit is saved,
wherein the target image data is image data that has been selected from among pieces of captured image data saved in the storage.

16. The image capturing apparatus according to claim 1, further comprising
a display that displays an image,
wherein the target image data is displayed on the display.

17. A control method for an image capturing apparatus including a first operation member that has a structure for operations in respective steps that include a first step and a second step, the control method comprising:
executing first processing with respect to target image data in response to the operation in the first step on the first operation member; and
executing second processing with respect to the target image data in response to the operation in the second step on the first operation member,
wherein the first processing is processing for performing one of rating setting and protection setting with respect to the target image data, and the second processing is processing for performing another one of the rating setting and the protection setting.

18. A non-transitory computer-readable storage medium storing a program that causes a computer to execute processing when loaded to and executed on the computer, the computer controlling an image capturing apparatus including a first operation member that has a structure for operations in respective steps that include a first step and a second step, the processing comprising:
executing first processing with respect to target image data in response to the operation in the first step on the first operation member; and
executing second processing with respect to the target image data in response to the operation in the second step on the first operation member,
wherein the first processing is processing for performing one of rating setting and protection setting with respect to the target image data, and the second processing is processing for performing another one of the rating setting and the protection setting.
